(19) United States
(12) Patent Application Publication
(10) Pub. No.: US 2019/0138916 A1
(43) Pub. Date: May 9, 2019

(54) COGNITIVE SYSTEM TO ITERATIVELY EXPAND A KNOWLEDGE BASE

(71) Applicant: International Business Machines Corporation, Armonk, NY (US)

(72) Inventors: Robert J. Allen, Jericho, VT (US); Adil Bhanji, Wappingers Falls, NY (US); Vasant B. Rao, Fishkill, NY (US); Peter A. Twombly, Shelburne, VT (US); Loma D. Vaishnav, Wappingers Falls, NY (US); Xin Zhao, Hopewell Junction, NY (US)

(21) Appl. No.: 15/807,618

(22) Filed: Nov. 9, 2017

(51) Int. Cl. G06N 5/02

(52) U.S. Cl. CPC G06N 5/022

(57) ABSTRACT

Aspects include creating a knowledge base that identifies experts in a set of domains. Front-end processing is provided to an issue tracking system. The front-end processing includes receiving a report of an issue related to one of the domains, and accessing the knowledge base to locate an expert in the domain. The front-end processing also includes instructing the issue tracking system to route the received report of the issue to the located expert in the domain. The issue tracking system executes on a different processor than the front-end processing. Data collected from operation of the issue tracking system is monitored, and the knowledge base is updated based at least in part on the data collected from the operation of the issue tracking system.

### BACKGROUND

Embodiments of the present invention relate in general to identifying subject matter experts, and more specifically to using data analytics to identify an expert in a subject area and to routing questions in the subject area to the identified expert.

An issue tracking system generally provides the user with a way to report an issue, track progression towards its resolution, and know who is responsible for resolving the issue. Many kinds of enterprises use issue tracking systems such as, but not limited to software developers, manufacturers, information technology (IT) help desks, and other service providers. It is not uncommon for problems entered into issue tracking systems to be sent to several people before finding the person with the correct expertise for solving the problem.

### SUMMARY

Embodiments of the present invention include methods, systems, and computer program products for using data analytics to identify an expert in a subject area. A non-limiting example method includes creating a knowledge base that identifies experts in a set of domains. Front-end processing is provided to an issue tracking system. The front-end processing includes receiving a report of an issue related to one of the domains, and accessing the knowledge base to locate an expert in the domain. The front-end processing also includes instructing the issue tracking system to route the received report of the issue to the located expert in the domain. The issue tracking system executes on a different processor than the front-end processing. Data collected from operation of the issue tracking system is monitored, and the knowledge base is updated based at least in part on the data collected from the operation of the issue tracking system.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a computer system for using data analytics to identify an expert in a subject area in accordance with one or more embodiments of the present invention;

FIG. 2 depicts a flow diagram for using data analytics to identify an expert in a subject area in accordance with one or more embodiments of the present invention;

FIG. 3 depicts a flow diagram for building a knowledge base using data analytics to identify an expert in a subject area in accordance with one or more embodiments of the present invention; and

FIG. 4 depicts a block diagram of a computer system for implementing some or all aspects of using data analytics to identify an expert in a subject area in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

In accordance with one or more embodiments of the present invention, a cognitive system that focuses on the discovery of expertise is provided. One or more embodiments of the present invention include the creation of a knowledge base about “who” can answer or resolve an identified issue.

In accordance with one or more embodiments of the present invention, the cognitive system identifies, evaluates, and judges human expertise so that the system can route a question to a person(s) likely to be able to answer the question. As the cognitive system is trained to connect potential answers to questions, it is further trained to recognize who tends to be able to answer questions of a particular kind. Thus, even if there is not sufficient information or structure to provide a high confidence answer from the data, relevant experts can be identified and contacted.

One or more embodiments of the present invention described herein can provide advantages over contemporary cognitive systems that use a knowledge base to route problems and questions to possible experts, such as chat bots and automated help desks. One or more embodiments of the present invention described herein provide a lower-cost initial value point when compared to contemporary cognitive systems by providing a relatively sparse initial knowledge base that can be expanded, or updated, based on observed data. The initial knowledge base can be built, for example, using human input, and then expanded automatically based, for example, on observed data collected from an issue tracking system. This also allows the knowledge base to be updated to reflect current knowledge about issues and possible experts.

In accordance with one or more embodiments of the present invention, a knowledge base that correlates experts and topics can be expanded and refined over time based on resolution data collected by an issue, or problem, tracking system. The knowledge base can be used to route a question to an identified expert in the absence of an answer to the question being located in data stored by the tracking system.

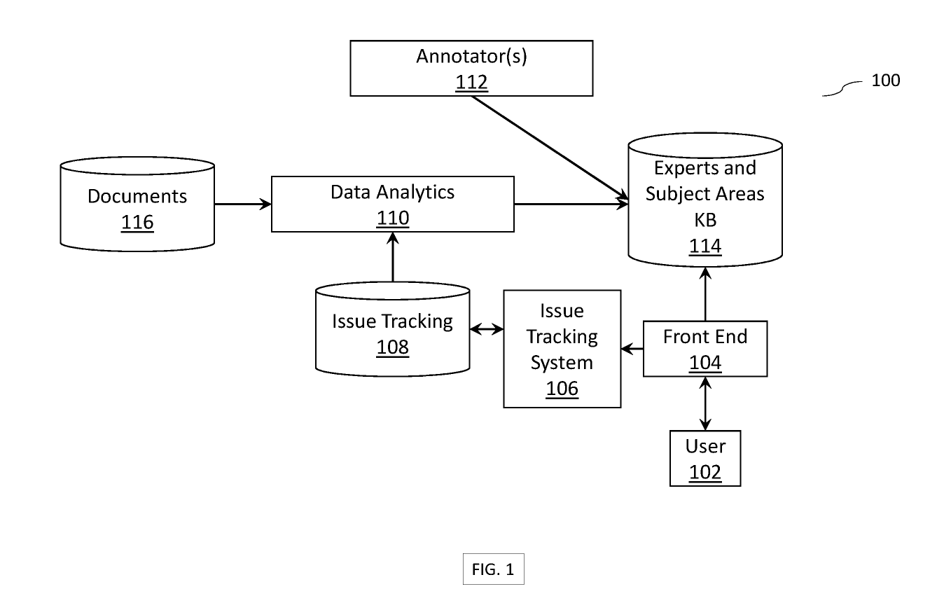

Turning now to FIG. 1, a block diagram of a computer system 100 for using data analytics to identify an expert in a subject area is generally shown in accordance with one or more embodiments of the present invention. FIG. 1 includes user 102 who is accessing a front-end 104 to an issue tracking system 106 to report a problem or issue. The tracking system 106 can be implemented by any system known in the art for tracking problems or issues. Examples include, but are not limited to IBM Rational ClearQuest® and IBM Rational Team Concert™. The tracking system 106 shown in FIG. 1 stores issue tracking data in an issue tracking database 108. Issue tracking data for a particular issue can include, but is not limited to: a tracking number; a status (e.g., closed, in-process, priority, current expert working on the issue, etc.); information about the user who reported the issue; information about expert(s) who have worked on the issue; text or structured data describing the problem, or issue; subject area(s) of issue; emails discussing the issue and/or requesting action or status about the issue; related issues; and/or how the issue was resolved.

As shown in FIG. 1, data analytics 110 are performed on contents of the issue tracking database 108 to pull out information about who solved particular types of issues in the past. This information is stored in an experts and subject areas knowledge base 114. Thus, the knowledge base 114 identifies people (“experts”) and their associated subject areas. As shown in FIG. 1, annotators 112 can be used to verify/update the contents of knowledge base 114. In addition, annotators 112 can enter data in the knowledge base 114 based on known experts and subject areas in order to initialize the knowledge base 114.

In accordance with one or more embodiments of the present invention, the knowledge base 114 is initialized using standard knowledge base construction techniques, however instead of (or in addition to) attempting to gather information on the subject matter of the system to be constructed, the questions to be answered are focused on “people who can answer the question.” The cognitive task analysis can include interviewing subject matter experts, with the subject matter experts being experts at finding people with expertise in particular subject areas, and on eliciting knowledge not of the answer to questions, but to who could answer it. Similarly, natural text processing and discovery methods can be used to analyze contents of documents 116 (e.g., technical papers or other documents) with the focus on either who authored or who is referenced in relevant documents. That is, the answer isn't the document, it's who wrote it or was cited in the document.

The knowledge base 114 can also be initialized by exploring a particular kind of data such as that contained in the issue tracking database 108. This can be conversational data, where a problem is discussed over time, and various authors contribute, leading eventually to the question being answered or the problem resolved. The information about how the state of the conversation (resolved, not resolved) changes can be combined with who contributes or is referenced (“I spoke to so-and-so, and . . . ”) in close proximity to the resolution to determine who actually answered the question or contributed to resolution of the issue. This is different from the information about who marked the problem resolved or who added a lot of content to the conversation (both of which may, or may not, be the correct expert for the issue). In other conversational systems, such as emails, that lack a formal marker of resolution, natural language processing can be used to recognize (e.g., who has been thanked), and thereby determine who provided the expertise to resolve the issue.

After obtaining the initial knowledge base 114 using techniques such as those described above, the knowledge base 114 can be integrated into a conversational issue tracking and routing system such as issue tracking system 106. As shown in FIG. 1, the knowledge base 114 is used as the front-end 104 to the issue tracking system 106. As the issue tracking system 106 is used, more data is provided that can be used to further explore and identify the expertise

The components shown in FIG. 1 can be located in one or more different geographic locations and connected via one or more networks. For example, the data analytics 110, issue tracking system 106, and front-end 104 can be executed on one or more different processors in one or more different locations. In addition, the documents 116, issue tracking database 108, and the knowledge base 114 can be physically stored in one or more storage devices in one or more geographic locations. In accordance with one or more embodiments of the present invention, the front-end 104 and the issue tracking system 106 are executed on different processors and they communicate via a network. For example, the issue tracking system 106 can be executed on a processor located in one geographic location and the front-end 104 executing on a processor located in a different geographic location, with the processors connected by the Internet.

In accordance with one or more embodiments of the present invention, when a small number of experts are called upon frequently, the system reacts by attempting to expand the knowledge base using the techniques described above with the same input data (which may have been updated since the last data analytics) or additional input data (e.g., widen the scope of documents analyzed). In one or more exemplary embodiments, the knowledge base 114 is updated periodically (weekly, monthly) and/or in response to a threshold number of updates (e.g., number of new problem reports entered, number of issues resolved, number of email communications) performed to the issue tracking database 108.

In accordance with one or more embodiments of the present invention, the front-end 104 receives the problem report from the user 102 and extracts key words/phrases for matching with contents of the knowledge base 114 to find an expert for resolving the problem. If the front-end 104 can locate an expert, the front-end 104 sends information about the identified expert to the issue tracking system 106. The issue tracking system 106 uses the information about the expert to route the problem report to the correct person (e.g., the identified expert). In this manner, the resolution of the problem report can be expedited by directing it to the correct person as soon as it is entered into the system.

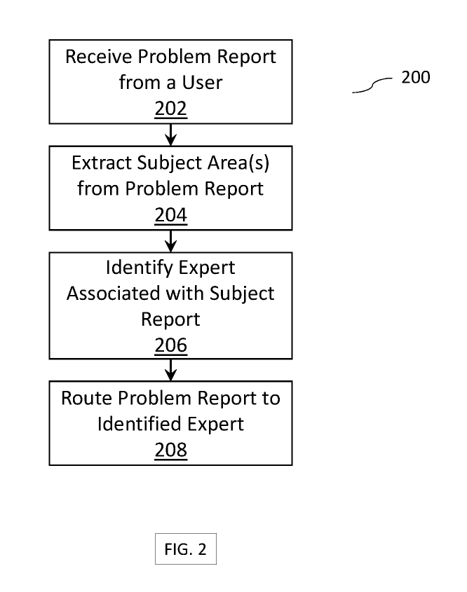

Turning now to FIG. 2, a flow diagram 200 for using data analytics to identify an expert in a subject area is generally shown in accordance with one or more embodiments of the present invention. The processing shown in FIG. 2 can be performed by computer instructions executed by a processor implementing the front-end 104 shown in FIG. 1. At block 202, a problem report from a user 102 is received at a user interface of the front-end 104. The subject area(s) of the problem report is extracted from the problem report at block 204. The extracting can be performed on text using any text analytics tool known in the art. The extracting can also be performed by locating defined entry areas in the problem report that contain words related to an expected subject area of expertise that is needed to solve the problem being reported. At block 206, the front-end 104 accesses the knowledge base 114 to identify an expert(s) associated with the extracted subject area(s). In accordance with one or more embodiments, the identification is performed using standard text matching techniques between the extracted subject area(s) and the subject areas in the knowledge base 114. At block 208, the front-end 104 instructs the issue tracking system 106 to route the problem report to one of the experts identified at block 206. By sending the problem directly to the correct expert, the amount of time to resolve the problem will be shortened and the number of resources required to work on the problem will be less (fewer emails trying to find the right person) when compared to conventional issue tracking systems. In accordance with one or more embodiments of the present invention, the front-end can keep track of how many times that it recommends a particular expert and can recommend other experts (if any are available) once the expert has been recommended more than a threshold number of times in a specified time period. In addition, the system can be triggered to expand by performing additional data analytics 110 (or human annotation) on the same or additional documents and/or issue tracking data in the issue tracking database 108. Further, the rules for assigning a subject area to an expert can be modified to identify additional or fewer experts in particular subject areas.

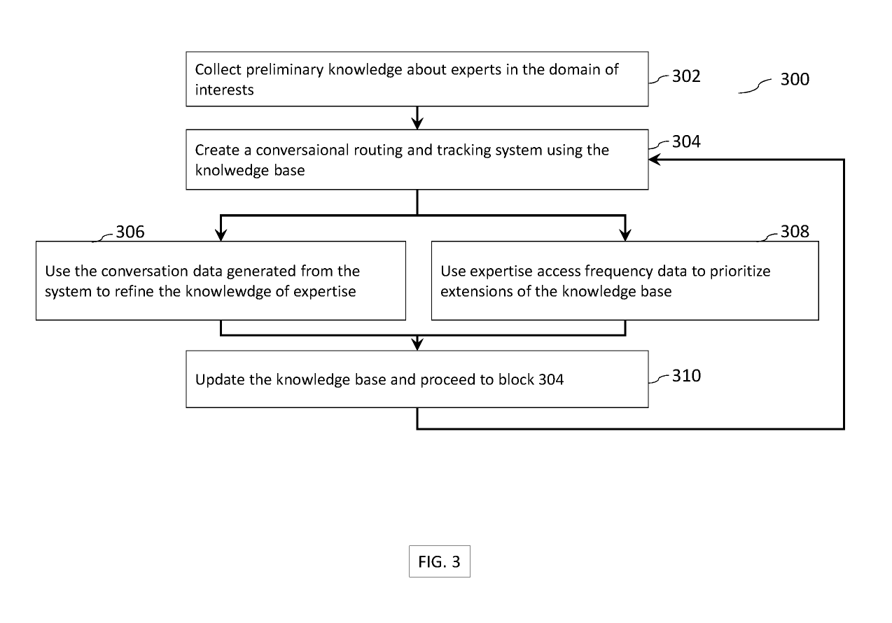

Turning now to FIG. 3, a flow diagram 300 for building a knowledge base using data analytics to identify an expert in a subject area is generally shown in accordance with one or more embodiments of the present invention. At block 302, an initial knowledge base, such as knowledge base 114 of FIG. 1, is created. The created knowledge base can include initial knowledge about experts in a set of domains (e.g., subject areas) of interest. At block 304, the knowledge base is used by a front-end, such as front-end 104 of FIG. 1, to a conversational system, such as issue tracking system 106 of FIG. 1, for answering questions and engaging the correct experts to solve problems. Data collected from the operation of the conversational system can be used to identify and prioritize the expansion of the knowledge base. At block 306, the conversation data collected from the operation of the conversational system is used to refine the knowledge of expertise in subject areas, that is, to identify the experts in particular domains. This can based on data in the issue tracking database 108 related to which experts are currently solving which problems, and can reflect changing expertise over time.

At block 308, expertise access frequency data is used to prioritize extensions of the knowledge base to add (or remove) experts to a domain. In accordance with one or more embodiments of the present invention deciding to add more experts is performed by identifying those experts who get asked more than a threshold number of questions which can indicate that the expert is in a domain area that has a high need relative to the depth of knowledge. At block 310, the output from blocks 306 and 308 are used as prioritized opportunities and information to incrementally increase the knowledge base with new domain knowledge and expertise location information.

Processing continues at block 304 where the operation of the conversational system reflects the improved knowledge base. Blocks 304, 306, 308, and 310 are repeated to grow the value of the conversational system over time. In this manner, the knowledge base is iteratively updated over time by monitoring the operation of the conversational system. Based on the monitoring, the knowledge base, which can be used to route problems reports to the correct experts, can be improved to reflect current observations.

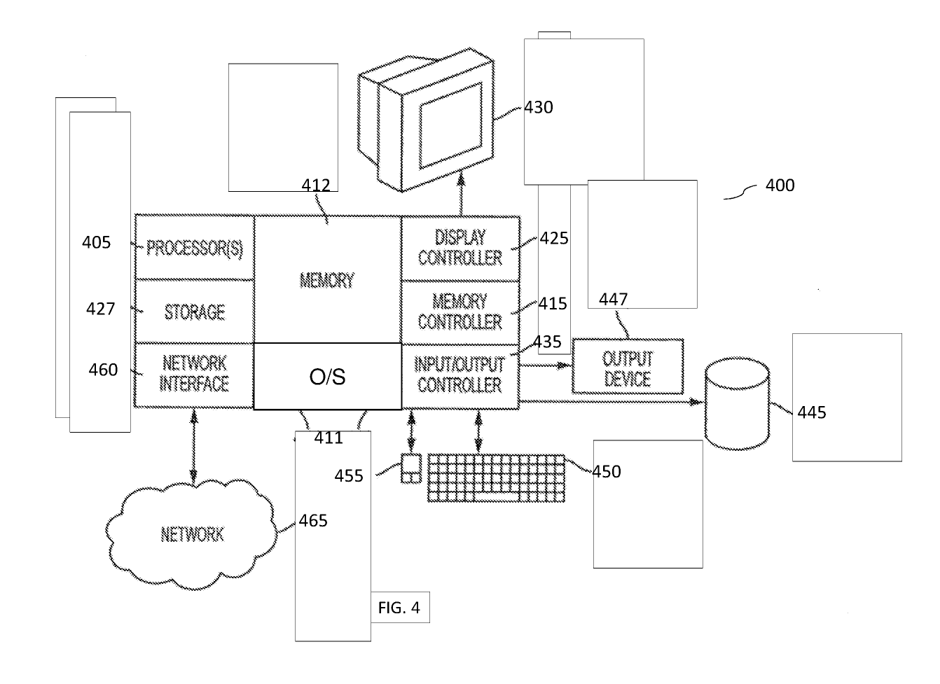

Turning now to FIG. 4, a block diagram of a computer system 400 for implementing some or all aspects of using data analytics to identify an expert in a subject area is generally shown according to one or more embodiments of the present invention. The processing described herein may be implemented in hardware, software (e.g., firmware), or a combination thereof. In an exemplary embodiment, the methods described may be implemented, at least in part, in hardware and may be part of the microprocessor of a special or general-purpose computer system 400, such as a mobile device, personal computer, workstation, minicomputer, or mainframe computer.

In an exemplary embodiment, as shown in FIG. 4, the computer system 400 includes a processor 405, memory 412 coupled to a memory controller 415, and one or more input devices 445 and/or output devices 447, such as peripherals, that are communicatively coupled via a local I/O controller 435. These devices 447 and 445 may include, for example, a printer, a scanner, a microphone, and the like. A conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 447, 445 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 412. The processor 405 may be a custom made or commercially available processor, a central processing unit (CPU), an auxiliary processor among several processors associated with the computer system 400, a semiconductor based microprocessor (in the form of a microchip or chip set), a microprocessor, or other device for executing instructions. The processor 405 can include a cache such as, but not limited to, an instruction cache to speed up executable instruction fetch, a data cache to speed up data fetch and store, and a translation look-aside buffer (TLB) used to speed up virtual-to-physical address translation for both executable instructions and data. The cache may be organized as a hierarchy of more cache levels (L1, L2, etc.).

The memory 412 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 412 may incorporate electronic, magnetic, optical, or other types of storage media. Note that the memory 412 may have a distributed architecture, where various components are situated remote from one another but may be accessed by the processor 405.

The instructions in memory 412 may include one or more separate programs, each of which comprises an ordered listing of executable instructions for implementing logical functions. In the example of FIG. 4, the instructions in the memory 412 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 427, which may be a storage device such as a hard disk drive or solid state drive. The stored instructions in memory 412 or in storage 427 may include those enabling the processor to execute one or more aspects of the dispatch systems and methods of this disclosure.

The computer system 400 may further include a display controller 425 coupled to a display 430. In an exemplary embodiment, the computer system 400 may further include a network interface 460 for coupling to a network 465. The network 465 may be an IP-based network for communication between the computer system 400 and an external server, client and the like via a broadband connection. The network 465 transmits and receives data between the computer system 400 and external systems. In an exemplary embodiment, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods for providing using data analytics to identify an expert in a subject area as described herein can be embodied, in whole or in part, in computer program products or in computer systems 400, such as that illustrated in FIG. 4.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
creating a knowledge base that identifies experts in a set of domains;
providing front-end processing to an issue tracking system, the front-end processing comprising:
receiving a report of an issue related to one of the domains;
accessing the knowledge base to locate an expert in the domain; and
instructing the issue tracking system to route the received report of the issue to the located expert in the domain, the issue tracking system executing on a different processor than the front-end processing;
monitoring data collected from operation of the issue tracking system; and
updating the knowledge base based at least in part on the data collected from the operation of the issue tracking system.

2. The method of claim 1, further comprising repeating the providing, monitoring, and updating.

3. The method of claim 1, wherein the updating includes identifying another expert for a domain in the set of domains.

4. The method of claim 1, wherein the updating includes removing an expert from a domain in the set of domains.

5. The method of claim 1, wherein the creating a knowledge base includes performing data analytics on data collected from the operation of the issue tracking system.

6. The method of claim 1, wherein the creating a knowledge base includes performing data analytics on documents related to the domain.

7. The method of claim 1, wherein the creating a knowledge base is based at least in part on input from an annotator.

8. The computer-implemented method of claim 1, wherein the updating is performed periodically.

9. The computer-implemented method of claim 1, wherein the updating is performed in response to a number of reports of issues sent to the located expert exceeding a threshold.

10. A system comprising:
a memory having computer readable instructions; and
one or more processors for executing the computer readable instructions, the computer readable instructions controlling the one or more processors to perform operations comprising:
receiving a knowledge base that identifies experts in a set of domains;
providing front-end processing to an issue tracking system, the front-end processing comprising:
receiving a report of an issue related to one of the domains;
accessing the knowledge base to locate an expert in the domain; and
instructing the issue tracking system to route the received report of the issue to the located expert in the domain, the issue tracking system executing on a different processor than the front-end processing;
monitoring data collected from operation of the issue tracking system; and
updating the knowledge base based at least in part on the data collected from the operation of the issue tracking system.

11. The system of claim 10, wherein the operations further comprise repeating the providing, monitoring, and updating.

12. The system of claim 10, wherein the updating includes one or both of identifying another expert for a domain in the set of domains, and removing an expert from a domain in the set of domains.

13. The system of claim 10, wherein the knowledge base is created based at least in part by performing data analytics on data collected from the operation of the issue tracking system.

14. The system of claim 10, wherein the knowledge base is created based at least in part by performing data analytics on documents related to the domain.

15. The system of claim 10, wherein the knowledge base is created at least in part based on input from an annotator.

16. The system of claim 10, wherein the updating is performed periodically.

17. The system of claim 10, wherein the updating is performed in response to a number of reports of issues sent to the located expert exceeding a threshold.

18. A computer program product comprising a computer readable storage medium having program instructions embodied therewith, the program instructions executable by a processor to cause the processor to perform operations comprising:
receiving a knowledge base that identifies experts in a set of domains;
providing front-end processing to a conversational issue tracking system, the front-end processing:
receiving a report of an issue related to one of the domains;
accessing the knowledge base to locate an expert in the domain; and
instructing the issue tracking system to route the received report of the issue to the located expert in the domain, the issue tracking system executing on a different processor than the front-end processing;
monitoring data collected from operation of the issue tracking system; and
updating the knowledge base based at least in part on the data collected from the operation of the issue tracking system.

19. The computer program product of claim 18, wherein the operations further comprise repeating the providing, monitoring, and updating.

20. The computer program product of claim 18, wherein the updating is performed periodically and in response to a number of reports of issues sent to the located expert exceeding a threshold.
